(19) United States
(12) Patent Application Publication
(10) Pub. No.: US 2024/0203090 A1
(43) Pub. Date: Jun. 20, 2024

(54) INFORMATION PROCESSING SYSTEM AND INFORMATION PROCESSING METHOD

(71) Applicant: SONY GROUP CORPORATION, TOKYO (JP)

(72) Inventor: HIROKAZU MORISHITA, TOKYO (JP)

(21) Appl. No.: 18/555,008

(22) PCT Filed: Feb. 1, 2022
(86) PCT No.: PCT/JP2022/003722

§ 371 Date: Oct. 12, 2023

(30) Foreign Application Priority Data
Apr. 30, 2021 (JP) 2021-077076

(51) Int. Cl. G06V 10/60; G06F 3/14

(52) U.S. Cl. CPC G06V 10/60; G06F 3/14

(57) ABSTRACT

The present technology relates to an information processing system and an information processing method which can detect a luminance range of video data and convert the luminance range into an appropriate luminance range. The information processing system according to an aspect of the present technology detects a luminance range of input data, and converts the luminance range of the input data on the basis of a detection result of the luminance range of the input data and outputs the luminance range. The present technology can be applied to a video wall, a TV, a display, and the like.

### TECHNICAL FIELD

The present technology relates to an information processing system and an information processing method, and more particularly to an information processing system and an information processing method capable of detecting a luminance range of video data and converting the detected luminance range into an appropriate luminance range.

### BACKGROUND ART

In general, as a method of expressing luminance of video data, any luminance method (luminance gradation method) of a Full Range using an expressible entire luminance range or a Limited Range using an intermediate region without using a partial region close to an upper limit and a lower limit of a luminance range is used.

In a case where video data is transmitted via a wired interface such as HDMI (registered trademark), a source (Source) device describes information associated with information regarding these luminance methods in metadata such as InfoFrame and transmits the information to a sink (Sink) device together with the video data.

For example, there is a technology of automatically recognizing a luminance level and controlling a luminance range of a video output of an output device to match a luminance range of an input signal as in Patent Document 1.

### CITATION LIST

### Patent Document

Patent Document 1: Japanese Patent Application Laid-Open No. 2008-22049

### SUMMARY OF THE INVENTION

### Problems to be Solved by the Invention

However, for example, in a case where a selector device that switches input data is arranged between a source device and a sink device in order to connect a plurality of source devices to the sink device, the information of the InfoFrame may be missing or may be inaccurate information due to format conversion or signal conversion in the selector device. In a system having such a configuration, in a case where the sink device performs setting of the luminance method on the basis of the information of the InfoFrame, there is a possibility that an accurate video signal cannot be reproduced.

The present technology has been made in view of such a circumstance, and enables detection of a luminance range of video data and conversion into an appropriate luminance range.

### Solutions to Problems

An information processing system according to an aspect of the present technology includes a detection unit that detects a luminance range of input data; and a conversion unit that converts the luminance range of the input data on the basis of a detection result of the detection unit and outputs the luminance range.

An information processing method according to another aspect of the present technology includes detecting a luminance range of input data by an information processing system; and converting the luminance range of the input data on the basis of a detection result of the luminance range of the input data and outputting the luminance range by the information processing system.

### BRIEF DESCRIPTION OF DRAWINGS

FIG. 1 is a diagram describing a configuration example of a display system of the present disclosure.

FIG. 2 is a diagram illustrating a configuration example of a video wall controller in FIG. 1.

FIG. 3 is a diagram illustrating a configuration example of a range detection unit in FIG. 2.

FIG. 4 is a diagram illustrating a configuration example of a range conversion unit in FIG. 2.

FIG. 5 is a diagram illustrating a configuration example of a part of a path selection unit in FIG. 4.

FIG. 6 is a diagram illustrating a configuration example of a selection blending unit in FIG. 4.

FIG. 7 is a diagram illustrating a state transition of luminance range conversion.

FIG. 8 is a diagram illustrating a state transition table summarizing state transitions.

FIG. 9 is a diagram illustrating a state transition table summarizing state transitions.

FIG. 10 is a diagram illustrating a state transition table summarizing state transitions.

FIG. 11 is a flowchart describing an operation of the video wall controller in FIG. 1.

FIG. 12 is a diagram illustrating a more detailed configuration example of a video wall controller in FIG. 1.

FIG. 13 is a diagram illustrating an example of a GUI displayed for setting a luminance range of input data.

FIG. 14 is a diagram illustrating a configuration example of a display device.

FIG. 15 is a diagram illustrating a configuration example of a computer.

### MODE FOR CARRYING OUT THE INVENTION

Hereinafter, embodiments for carrying out the present technology will be described. The description will be made in the following order.
1. System configuration
2. Detailed configuration of video wall controller
3. Description of operation of video wall controller
4. Setting method of luminance range
5. Modified examples

### <<System Configuration>>

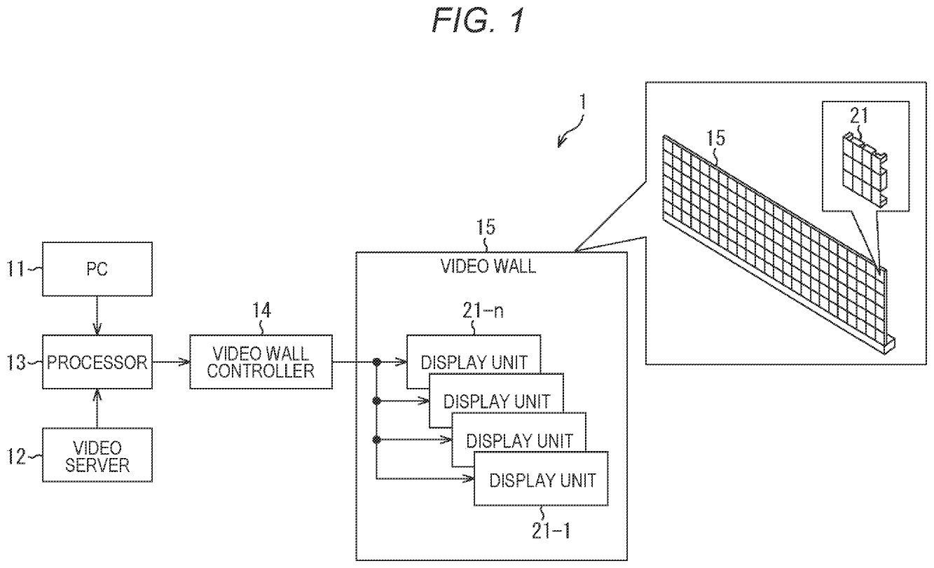

FIG. 1 illustrates a configuration example of a display system to which the technology of the present technology is applied.

A display system 1 in FIG. 1 displays video content on a large display including a plurality of display units arranged in a tile shape.

More specifically, the display system 1 includes a personal computer (PC) 11, a video server 12, a processor 13, a video wall controller 14, and a video wall 15.

The PC 11 is a general-purpose computer, and outputs video data such as video content to the video wall controller 14.

The video server 12 includes, for example, a server computer and the like, and outputs video data such as video content to the video wall controller 14.

The processor 13 includes an interface for the connection to a plurality of video output devices, performs format conversion and signal conversion on the video data input from the PC 11 and the video server 12, and selectively outputs the data input from any of the video output devices to the video wall controller 14.

The video wall controller 14 distributes and displays the video data of the video content to display units 21-1 to 21-n constituting the video wall 15.

Note that the display units 21-1 to 21-n will be referred to as a display unit 21 in a case where the display units are not necessary to be individually distinguished from each other.

As illustrated in a balloon on an upper right part of FIG. 1, the video wall 15 is formed by arranging the display units 21-1 to 21-n, in which pixels including LEDs are arranged in an array, in a tile shape. The video wall 15 displays one image on the entire video wall 15 by combining images displayed on the individual display units 21.

The video wall controller 14 performs predetermined signal processing on the video data of the video content input from the processor 13, distributes the video data according to the arrangement of the display units 21-1 to 21-n, and outputs the video data. The video wall controller 14 controls individual display of the display units 21-1 to 21-n such that the video wall 15 displays one image as a whole.

The video wall controller 14 functions as an information processing system that controls the display of the video wall 15 on the basis of the video data of the video content input from the processor 13. Note that the video wall controller 14 and the video wall 15 may be configured as a display device (information processing device) in which the video wall controller 14 and the video wall 15 are integrated.

Furthermore, the PC 11 and the processor 13, the video server 12 and the processor 13, and the processor 13 and the video wall controller 14 are connected by using any one of a local area network (LAN) cable, a high definition multimedia interface (HDMI) cable, a display port (DP) cable, a digital visual interface (DVI) cable, a serial digital interface (SDI) cable, and wireless communication. However, the connected interface is not limited to these examples. Furthermore, the respective devices may be connected by different connection interfaces.

### <<Detailed Configuration of Video Wall Controller>>

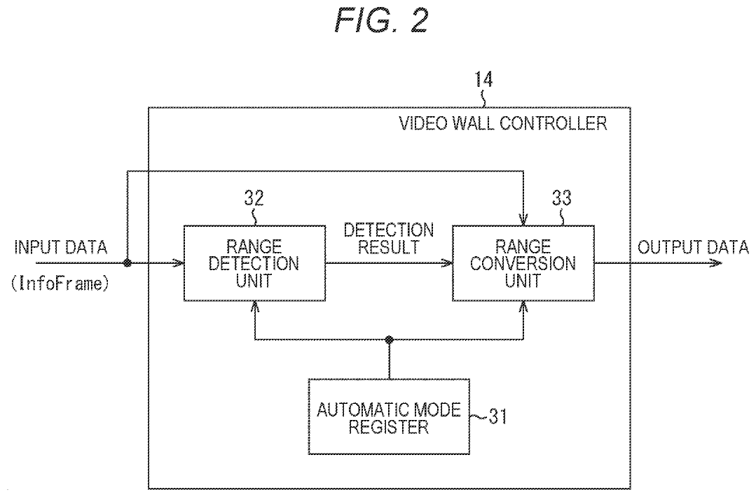

FIG. 2 is a block diagram illustrating a functional configuration example of the video wall controller 14.

The video wall controller 14 in FIG. 2 includes an automatic mode register 31, a range detection unit 32, and a range conversion unit 33.

The video wall controller 14 detects a luminance range of the video data input from the processor 13, converts the luminance range of the video data according to the detection result, and outputs the converted luminance range of the video data to the video wall 15.

The video data output from the processor 13 is input to the range detection unit 32 as input data. Sync (synchronization signal) is also input to the range detection unit 32.

In a case where HDMI and the like are used as the interface between the processor 13 and the video wall controller 14, InfoFrame is input to the range detection unit 32. The InfoFrame is included in the input data. Hereinafter, a case where the interface between the processor 13 and the video wall controller 14 is the HDMI will be mainly described.

The automatic mode register 31 stores ON/OFF setting information indicating whether or not to automatically detect the luminance range, that is, whether the luminance range detection function is ON or OFF. The automatic mode register 31 stores, for example, the ON/OFF setting information according to setting by a user. The ON/OFF setting information of the luminance range detection function is input to the range detection unit 32 and the range conversion unit 33.

The range detection unit 32 acquires the input data, sync, and InfoFrame input from the processor 13. In a case where the ON/OFF setting information stored in the automatic mode register 31 indicates that the luminance range detection function is ON, the range detection unit 32 detects the luminance range of the input data.

The range detection unit 32 detects whether or not the luminance level (for example, the maximum luminance and the minimum luminance) of the input data is within the Limited Range. In a case of detecting that the luminance level of the input data is outside the Limited Range, the range detection unit 32 outputs a detection result indicating that the luminance range of the input data is Full Range to the range conversion unit 33. Note that in a case of detecting that the luminance level of the input data is within the Limited Range, the range detection unit 32 may output a detection result indicating that the luminance range of the input data is the Limited Range to the range conversion unit 33.

Furthermore, the range detection unit 32 may determine whether or not the detection result of the luminance range matches the luminance range indicated by the InfoFrame, and in a case where the detection result does not match the luminance range indicated by the InfoFrame, the range detection unit 32 may output notification information for providing notification of the fact.

The range conversion unit 33 converts the luminance range of the input data on the basis of the detection result of the luminance range input from the range detection unit 32, and outputs the input data after the conversion of the luminance range as output data.

However, in a case where the conversion of the luminance range is not necessary, the range conversion unit 33 outputs the input data as it is without converting the luminance range. For example, in a case where the luminance range of the input data is the same luminance range as the luminance range set by the user as the luminance range of the output data, the processing is performed assuming that the conversion of the luminance range is not necessary. As described later, the user sets ON/OFF of the luminance range detection function, the luminance range of the input data, and the luminance range of the output data.

### <Range Detection Unit>

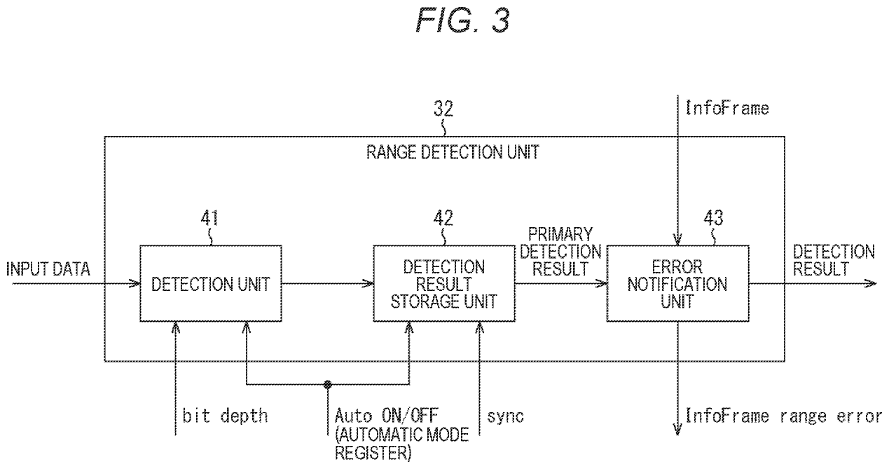

FIG. 3 is a block diagram illustrating a functional configuration example of the range detection unit 32.

The range detection unit 32 includes a detection unit 41, a detection result storage unit 42, and an error notification unit 43.

The sync is input to the detection result storage unit 42, and the InfoFrame included in the input data is input to the error notification unit 43.

The video data output from the processor 13 is input to the detection unit 41 as input data. Furthermore, bit depth (bit depth information) is input to the detection unit 41.

The bit depth is information representing a gradation of the luminance (or color information) with a predetermined bit depth. For example, in a case where the bit depth is 8 bits, the luminance is represented by 256 gradations of 0 to 255.

In addition to 8 bits, a bit depth of 10 bits, 12 bits, or 16 bits is used. The bit depth of a larger bit depth may indicate more luminance gradations. However, a bit depth of a bit depth larger than 16 bits may be used, or a bit depth of a bit depth smaller than 8 bits may be used.

In the HDMI standard, the bit depth is stored in a packet called a general control packet included in input data, and is input from the processor 13 to the detection unit 41.

In a case where the luminance range detection function is ON, the detection unit 41 detects whether the luminance range of the input data is Full Range or Limited Range on the basis of the value of bit depth. In a case where it is detected that the luminance level of the input data is outside the Limited Range and the luminance range is the Full Range, the detection unit 41 outputs, for example, information with a value of 1 indicating the fact to the detection result storage unit 42 as the detection result of the luminance range.

The luminance range using the entire luminance range that can be expressed by the bit depth indicated by bit depth is Full Range, and the luminance range using the intermediate region without using a part of the region close to the upper limit and the lower limit of the Full Range is Limited Range. The region that is outside the Limited Range and is close to the upper limit and the lower limit of the Full Range is determined by the value of bit depth.

For example, in a case where the bit depth is 8 bits, the luminance range using all 256 gradations of 0 to 255 is the Full Range. The luminance range using gradations in a range of 16 to 235 excluding a part of a high luminance region and a part of a low luminance region of the Full Range is the Limited Range.

That is, in a case where the maximum luminance of the input data is the luminance of the high luminance region outside the Limited Range or the minimum luminance is the luminance of the low luminance region outside the Limited Range, the detection unit 41 outputs the detection result of a value of 1 to the detection result storage unit 42.

In the luminance range detection processing, the power consumption is increased by continuing the signal detection in a case where the luminance range is not detected. Therefore, in order to prevent an increase in power consumption due to the luminance range detection processing, in a case where the luminance range detection function is OFF, a fixed value of a value of 0 may be used as the value output by the detection unit 41.

The detection result of the luminance range output from the detection unit 41 and the sync are input to the detection result storage unit 42.

The detection result storage unit 42 stores the value input from the detection unit 41 in a case where the luminance range detection function is ON. In a case where the detection result of, for example, a value of 1 indicating the detection of the Full Range is input from the detection unit 41 even once, the detection result storage unit 42 stores the value.

The detection result storage unit 42 outputs, for example, a temporary detection result of the luminance range of the input data to the error notification unit 43 on the basis of the stored value. The temporary detection result is output, for example, after the luminance range detection function is turned on by the user and in a case where the vertical synchronization period is ended.

Note that in a case where a value indicating the detection result indicating the Full Range is input from the detection unit 41, the detection result storage unit 42 may immediately output the temporary detection result regardless of the sync. In this case, the range detection unit 32 may not include the detection result storage unit 42.

The temporary detection result output from the detection result storage unit 42 and the InfoFrame are input to the error notification unit 43.

The error notification unit 43 determines whether or not the luminance range indicated by the temporary detection result matches the luminance range indicated by the InfoFrame. In a case where the luminance range indicated by the temporary detection result matches the luminance range indicated by the InfoFrame, the error notification unit 43 outputs the temporary detection result to the range conversion unit 33 as the detection result of the luminance range.

Furthermore, in a case where the luminance range indicated by the temporary detection result does not match the luminance range indicated by the InfoFrame, the error notification unit 43 outputs notification information (InfoFrame range error) for providing notification of the fact. Also in this case, the error notification unit 43 outputs the temporary detection result to the range conversion unit 33 as the detection result of the luminance range.

For example, the notification information indicating that the luminance range indicated by the temporary detection result does not match the luminance range indicated by the InfoFrame may be output to the video wall 15 or may be output to an output unit (for example, the display unit) (not illustrated) included in the video wall controller 14. Furthermore, the notification information may be output from an output device other than the video wall 15 connected to the video wall controller 14. The notification information may be an image or may be information other than an image such as voice.

As described above, the notification information indicating that the luminance range indicated by the temporary detection result does not match the luminance range indicated by the InfoFrame is output, so that the user can understand that incorrect signal transmission is performed in the previous stage of the video wall controller 14. With this notification information, the user can take measures such as replacing a device that performs incorrect signal transmission with another device.

By the luminance range detection processing of the input data described above, even in a case where the missing of the InfoFrame or the incorrect transmission of the InfoFrame occurs in the processor 13, the video wall controller 14 can automatically detect and convert the luminance range of the video data regardless of the presence or absence of the InfoFrame. Therefore, it is possible to prevent erroneous setting of the luminance range on the basis of the information of the InfoFrame and to reproduce the video content accurately reflecting the creator's intention.

### <Range Conversion Unit>

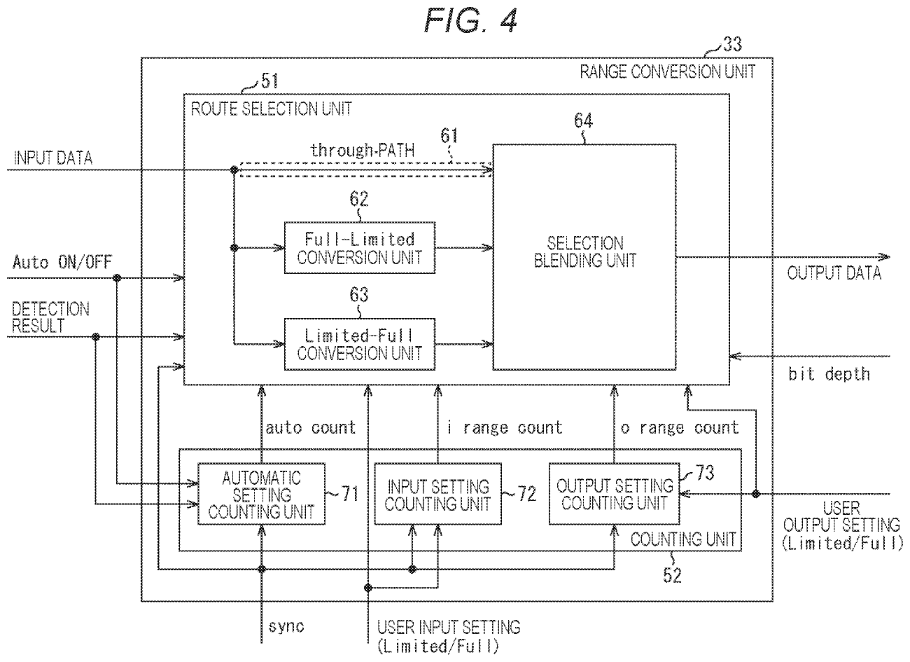

FIG. 4 is a block diagram illustrating a functional configuration example of the range conversion unit 33.

The range conversion unit 33 includes a path selection unit 51 and a counting unit 52.

The path selection unit 51 includes a through-path 61, a Full-Limited conversion unit 62, a Limited-Full conversion unit 63, and a selection blending unit 64.

The counting unit 52 includes an automatic setting counting unit 71, an input setting counting unit 72, and an output setting counting unit 73.

The ON/OFF setting information of the luminance range detection function output from the automatic mode register 31 is input to the path selection unit 51, and the detection result output from the range detection unit 32 is input to the path selection unit 51. The input data that is video data is also input to the path selection unit 51.

Furthermore, auto count, i range count, and o range count output from the counting unit 52 are input to the path selection unit 51. The bit depth and the sync are input to the path selection unit 51. User input setting which is setting information of the luminance range of the input data and user output setting which is setting information of the luminance range of the output data are input to the path selection unit 51.

The user input setting is, for example, setting for fixedly selecting which of the Limited Range and the Full Range the luminance range of the input data input to the range conversion unit 33 is, or for selecting to automatically detect the luminance range using the luminance range detection function. Note that the user input setting is not necessarily performed, and may be turned off. In this case, for example, the luminance range of the input data is determined using the information of the InfoFrame.

In a case where the user input setting is a setting for automatically detecting the luminance range using the luminance range detection function, the automatic mode register 31 stores the ON/OFF setting information indicating that the luminance range detection function is ON. Note that, for example, during a period from when the luminance range detection function is turned on until the range detection unit 32 detects that the luminance range of the input data is the Full Range, the luminance range of the input data is regarded as the Limited Range.

In a case where the user input setting is setting other than the setting for automatically detecting the luminance range using the luminance range detection function, the automatic mode register 31 stores the ON/OFF setting information indicating that the luminance range detection function is OFF. For example, in a case where the luminance range detection function is OFF, whether the luminance range of the input data is set to the Limited Range or the Full Range is set.

The user output setting is, for example, setting for fixedly selecting whether the luminance range of the output data output from the range conversion unit 33 is any luminance range of the Limited Range and the Full Range. Note that the user output setting is not necessarily performed, and may be turned off. In this case, the luminance range of the input data is output as it is as the output data without being converted.

The user input setting and the user output setting are performed by the user using, for example, an interface provided in the video wall controller 14 or a device connected to the video wall controller 14.

The through-path 61 outputs the luminance range of the input data as it is without conversion.

The Full-Limited conversion unit 62 converts the luminance range of the input data from the Full Range to the Limited Range.

The Limited-Full conversion unit 63 converts the luminance range of the input data from the Limited Range to the Full Range.

The input data passing through three paths, that is, the through-path 61, a path passing through the Full-Limited conversion unit 62, and a path passing through the Limited-Full conversion unit 63 is input to the selection blending unit 64.

Note that, in the following description, it is assumed that the input data is input through three paths, but the input method of the input data is not limited thereto. For example, the input data may be input only to one or two paths corresponding to the output required in the selection blending unit 64.

Furthermore, the Full-Limited conversion unit 62 and the Limited-Full conversion unit 63 may be enabled according to the output required in the selection blending unit 64 and the detection result of the luminance range input from the range detection unit 32.

The selection blending unit 64 selects one of the input data input through the three paths on the basis of the detection result of the luminance range input from the range detection unit 32, and outputs the selected input data as the output data. The output data is output to the video wall 15, and is used for displaying a video of video content.

Furthermore, in a case where the luminance range of the output data is switched, the selection blending unit 64 may select the input data such that the luminance of the output data gently changes.

The sync, the ON/OFF setting information of the luminance range detection function, and the detection result of the range detection unit 32 are input to the automatic setting counting unit 71. The sync and the user input setting are input to the input setting counting unit 72. The sync and the user output setting are input to the output setting counting unit 73.

The automatic setting counting unit 71 counts an elapsed time after the luminance range of the input data is changed due to the luminance range detection function being turned on from off. Specifically, the elapsed time after the luminance range of the input data is changed due to the luminance range detection function being turned on and after the luminance range of the input data is changed due to the input of the detection result indicating the Full Range is counted. The automatic setting counting unit 71 outputs the auto count, which is the counted time information, to the path selection unit 51.

The input setting counting unit 72 counts the elapsed time after the luminance range of the input data is changed due to the user input setting being set to the Limited Range or the Full Range. The input setting counting unit 72 outputs the i range count, which is the counted time information, to the path selection unit 51.

The output setting counting unit 73 counts the elapsed time after the luminance range of the output data is changed due to the change in the user output setting. The output setting counting unit 73 outputs the o range count, which is the counted time information, to the path selection unit 51.

The automatic setting counting unit 71, the input setting counting unit 72, and the output setting counting unit 73 count a v section (section between the vertical synchronization signals) on the basis of the sync, as the elapsed time. However, the method of counting time is not limited to the sync, and time information may be acquired from a clocking unit (not illustrated) to count the auto count, the i range count, and the o range count.

### <Three Paths of Path Selection Unit>

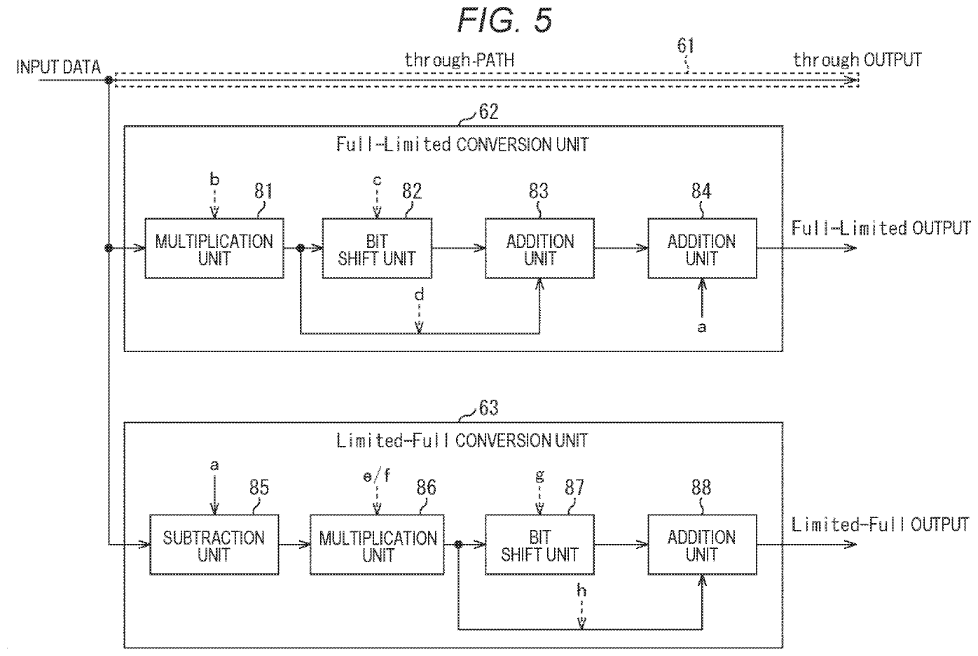

FIG. 5 is a block diagram illustrating a functional configuration example of the Full-Limited conversion unit 62 and the Limited-Full conversion unit 63 constituting the path selection unit 51. FIG. 5 illustrates the through-path 61 together with the configurations of the Full-Limited conversion unit 62 and the Limited-Full conversion unit 63.

The through-path 61 outputs the input data as it is as a through output without converting the luminance range of the input data. The through output is input to the selection blending unit 64.

The Full-Limited conversion unit 62 includes a multiplication unit 81, a bit shift unit 82, an addition unit 83, and an addition unit 84. The Full-Limited conversion unit 62 converts the luminance range of the input data from the Full Range to the Limited Range, and outputs the converted input data of the Limited Range as Full-Limited output. The Full-Limited output is input to the selection blending unit 64.

The multiplication unit 81 multiplies the input data by a bit depth-dependent fixed value b. In a case where the bit depth is 8 bits, the fixed value b is 225. The input data subjected to the multiplication processing is input to the bit shift unit 82 and the addition unit 83.

The bit shift unit 82 performs right bit shift processing based on a bit depth-dependent fixed value c on the input data input from the multiplication unit 81. In a case where the bit depth is 8 bits, since the fixed value c is 8, the bit shift unit 82 performs 8-bit right bit shift processing. The input data subjected to the right bit shift processing is input to the addition unit 83.

The addition unit 83 adds a d-th (d is a bit depth-dependent fixed value) bit of the input data input from the multiplication unit 81 to the input data input from the bit shift unit 82. In a case where the bit depth is 8 bits, since the fixed value d is 8, the addition unit 83 adds the 8-th bit of the input data output from the multiplication unit 81 to the input data input from the bit shift unit 82. The processing of the addition unit 83 corresponds to rounding off the floating point of the input data input from the bit shift unit 82. The input data subjected to the addition processing is input to the addition unit 84.

The addition unit 84 adds a bit depth-dependent fixed value a to the input data input from the addition unit 83. In a case where the bit depth is 8 bits, the fixed value a is 16. The input data subjected to the addition processing is input to the selection blending unit 64 as the Full-Limited output.

The Limited-Full conversion unit 63 includes a subtraction unit 85, a multiplication unit 86, a bit shift unit 87, and an addition unit 88. The Limited-Full conversion unit 63 converts the luminance range of the input data from the Limited Range to the Full Range, and outputs the converted input data of the Full Range as Limited-Full output. The Limited-Full output is input to the selection blending unit 64.

The subtraction unit 85 subtracts the bit depth-dependent fixed value a from the input data. In a case where the bit depth is 8 bits, the fixed value a is 16. The input data subjected to the subtraction processing is input to the multiplication unit 86.

The multiplication unit 86 multiplies the input data by e/f on the basis of the bit depth-dependent fixed values e and f. In a case where the bit depth is 8 bits, since the fixed value e is 256 and the fixed value f is 225, the multiplication unit 86 performs processing of multiplying the input data by 256/225. The input data subjected to the multiplication processing is input to the bit shift unit 87 and the addition unit 88.

The bit shift unit 87 performs right bit shift processing based on a bit depth-dependent fixed value g on the input data input from the multiplication unit 86. In a case where the bit depth is 8 bits, since the fixed value g is 15, the bit shift unit 87 performs 15-bit right bit shift processing. The input data subjected to the right bit shift processing is input to the addition unit 88.

The addition unit 88 adds a h-th (h is a bit depth-dependent fixed value) bit of the input data input from the multiplication unit 86 to the input data input from the bit shift unit 87. In a case where the bit depth is 8 bits, since the fixed value h is 15, the addition unit 88 adds the 15-th bit of the input data output from the multiplication unit 86 to the input data input from the bit shift unit 87. The processing of the addition unit 88 corresponds to rounding off the floating point of the input data input from the bit shift unit 87. The input data subjected to the addition processing is input to the selection blending unit 64 as the Limited-Full output.

### <Selection Blending Unit>

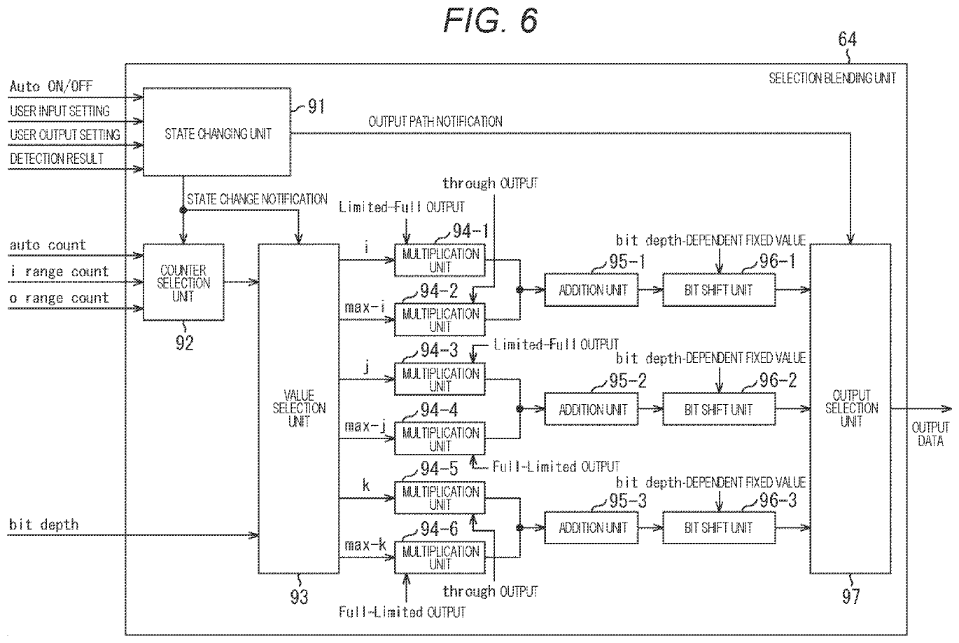

FIG. 6 is a block diagram illustrating a functional configuration example of the selection blending unit 64.

The selection blending unit 64 includes a state changing unit 91, a counter selection unit 92, a value selection unit 93, multiplication units 94-1 to 94-6, addition units 95-1 to 95-3, bit shift units 96-1 to 96-3, and an output selection unit 97. Note that the multiplication units 94-1 to 94-6, the addition units 95-1 to 95-3, and the bit shift units 96-1 to 96-3 will be respectively referred to as a multiplication unit 94, an addition unit 95, and a bit shift unit 96 in a case where the units are not necessary to be individually distinguished from each other.

The detection result of the luminance range output from the range detection unit 32 is input to the state changing unit 91, and the ON/OFF setting information of the luminance range detection function output from the automatic mode register 31 is input to the state changing unit 91. The user input setting which is the setting information of the luminance range of the input data and the user output setting which is the setting information of the luminance range of the output data are also input to the state changing unit 91.

The state changing unit 91 outputs a state change notification to the counter selection unit 92 and the value selection unit 93 on the basis of the detection result of the luminance range, the ON/OFF setting information of the luminance range detection function, the user input setting, and the user output setting. The state changing unit 91 outputs an output selection notification used to select data to be output, to the output selection unit 97.

The state changing unit 91 outputs the state change notification to the counter selection unit 92 and the value selection unit 93 on the basis of, for example, a state transition table defining a state transition (state change) of luminance range conversion. The state changing unit 91 outputs an output path notification to the output selection unit 97 on the basis of the state transition table, for example.

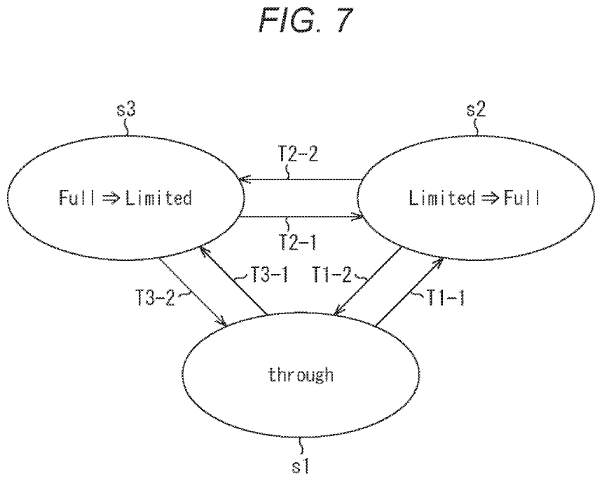

Here, the state transition (state change) of the luminance range conversion will be described with reference to FIG. 7.

As illustrated in FIG. 7, three states of a state s1 to a state s3 corresponding to the states of the luminance range conversion between the input data input to the range conversion unit 33 and the output data output from the range conversion unit 33 are defined.

The state s1 corresponds to the through output. In the state s1, the range conversion unit 33 outputs the data without performing the luminance range conversion on the input data.

The state s2 corresponds to the Limited-Full output. In the state s2, the range conversion unit 33 performs the luminance range conversion on the input data of the Limited Range, and outputs the data of the Full Range.

The state s3 corresponds to the Full-Limited output. In the state s3, the range conversion unit 33 performs the luminance range conversion on the input data of the Full Range, and outputs the data of the Limited Range.

As indicated by the arrows in FIG. 7, the transition between the state s1 and the state s2 is represented as transitions T1-1 and T1-2. The transitions between the state s2 and the state s3 are represented as transitions T2-1 and T2-2. The transitions between the state s3 and the state s1 are represented as transitions T3-1 and T3-2.

The transitions T1-1 to T3-2 occur in a case where any of the setting of ON/OFF of the luminance range detection function, the detection of the Full Range in a case where the luminance range detection function is ON, the setting of the luminance range of the input data, and the setting of the luminance range of the output data occurs.

The transition T1-1 and the transition T1-2 correspond to the transitions between the states s1 and s2. The transition T1-1 is a transition from the state s1 in which the luminance range conversion is not performed on the input data, to the state s2 in which the luminance range conversion is performed on the input data of the Limited Range and the data of the Full Range is output. The transition T1-2 is a transition from the state s2 to the state s1.

The transition T2-1 and the transition T2-2 correspond to the transitions between the states s2 and s3. The transition T2-1 is a transition from the state s3 in which the luminance range conversion is performed on the input data of the Full Range and the data of the Limited Range is output, to the state s2 in which the luminance range conversion is performed on the input data of the Limited Range and the data of the Full Range is output. The transition T2-2 is a transition from the state s2 to the state s3.

The transition T3-1 and the transition T3-2 correspond to the transitions between the states s1 and s3. The transition T3-1 is a transition from the state s1 in which the luminance range conversion is not performed on the input data, to the state s3 in which the luminance range conversion is performed on the input data of the Full Range and the data of the Limited Range is output. The transition T3-2 is a transition from the state s3 to the state s1.

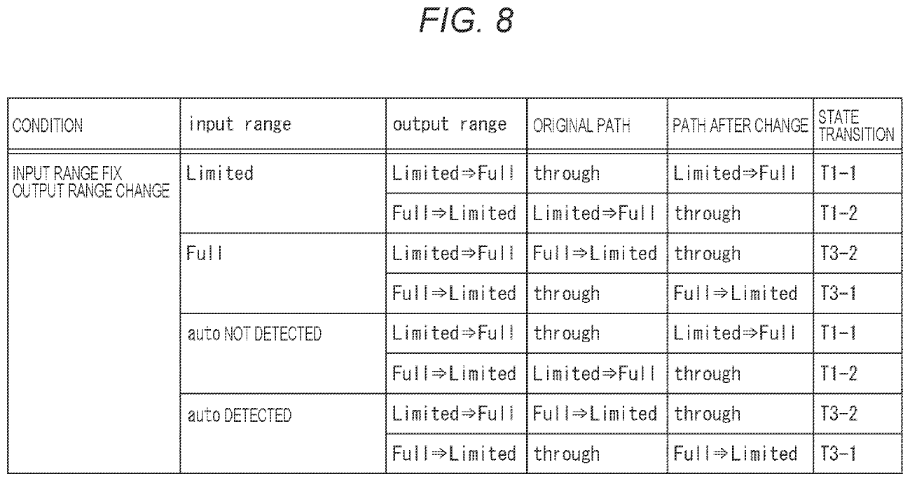

Next, conditions under which the transitions T1-1 to T3-2 occur will be described with reference to FIGS. 8 to 10.

FIGS. 8 to 10 illustrate the state transition tables summarizing the state transitions occurring under respective conditions. The state transition tables illustrated in FIGS. 8 to 10 have six columns of “condition”, “input range”, “output range”, “original path”, “path after change”, and “state transition”.

The “condition” indicates the condition under which the state transition occurs. The “input range” indicates an input luminance range that is a luminance range of the input data corresponding to the condition. The “output range” indicates an output luminance range that is a luminance range of the output data corresponding to the condition. The “original path” indicates a path of the path selection unit 51 (or the input data input via the path) selected by the selection blending unit 64 before the occurrence of the state transition. The “path after change” indicates a path of the path selection unit 51 (or the input data input via the path) selected by the selection blending unit 64 after the occurrence of the state transition. The “state transition” indicates a state transition corresponding to the path change.

FIG. 8 illustrates the state transition in a case where the input luminance range is fixed and the output luminance range is changed. The state transition table of FIG. 8 corresponds to the state transition in a case where the user input setting is not changed and the user output setting is changed. However, even in a case where the user input setting is not changed and the user output setting is changed, the state transition table of FIG. 8 does not correspond to a case where the luminance range detection function is ON, that is, in a case where the detection result of the luminance range of the input data is changed from the non-detection (Limited Range) state to the detection (Full Range) state in a state where the user input setting indicates ON of the luminance range detection function.

Note that the state of the non-detection (Limited Range) of the detection result of the luminance range of the input data is a state in which the detection unit 41 (FIG. 3) does not detect that the luminance range of the input data is the Full Range or a state in which the detection result of the Full Range is not output from the detection result storage unit 42 (FIG. 3).

In the state transition table of FIG. 8, the input luminance range is fixed. The input range is any state of the Limited Range, the Full Range, the luminance range detection result “not detected” (auto not-detected), and the luminance range detection result “detected” (auto detected).

In the state transition table of FIG. 8, the output luminance range is changed. The output range is either a change from the Limited Range to the Full Range or a change from the Full Range to the Limited Range.

The original path, the path after change, and the state transition are uniquely determined from the input range and the output range. The same applies to any of the state transition tables in FIGS. 8 to 10.

As an example, the state transition in a case where the input range is the Limited Range in the state transition table of FIG. 8 (second and third rows from the top) will be described.

In a case where the output range is changed from the Limited Range to the Full Range, since the input luminance range is the Limited Range and the output luminance range before the change is also the Limited Range, the original path is the through-path 61 (through output). In this case, since the input luminance range is the Limited Range and the output luminance range after the change is the Full Range, the path after the change is a path (Limited-Full output) passing through the Limited-Full conversion unit 63. Therefore, the state transition is the transition T1-1 corresponding to the state transition from the through output to the Limited-Full output.

In a case where the output range is changed from the Full Range to the Limited Range, since the input luminance range is the Limited Range and the output luminance range before the change is the Full Range, the original path is a path (Limited-Full output) passing through the Limited-Full conversion unit 63. In this case, since the input luminance range is the Limited Range and the output luminance range after the change is the Limited Range, the path after the change is the through-path 61 (through output). Therefore, the state transition is the transition T1-2 corresponding to the state transition from the Limited-Full output to the through output.

Although description is omitted, in the state transition table of FIG. 8, the original path, the path after change, and the state transition can be determined from the input range and the output range similarly in a case where the input range is the Full Range (fourth and fifth rows from the top), in a case where the luminance range detection function is ON and the detection result is not detected (Limited Range) (sixth and seventh rows from the top), and in a case where the luminance range detection function is ON and the detection result is detected (Full Range) (eighth and ninth rows from the top).

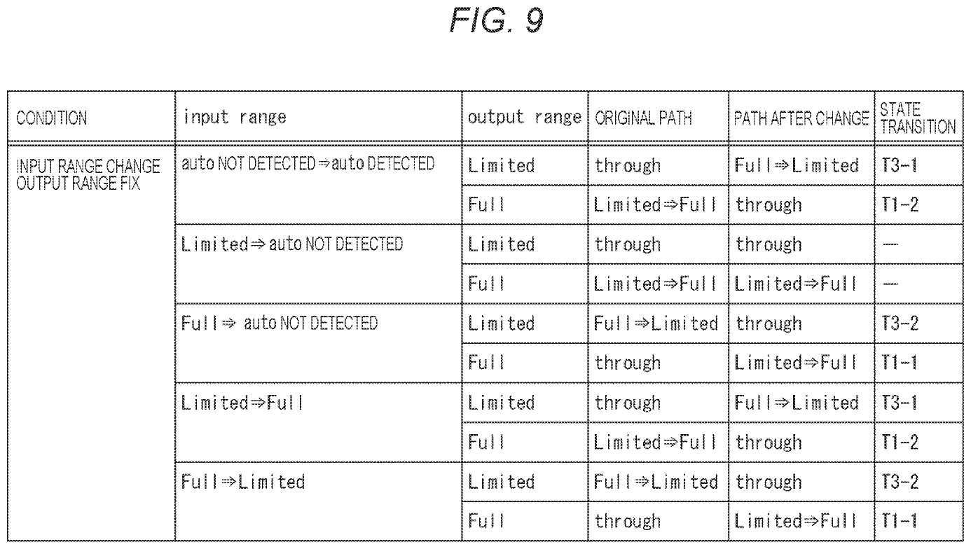

FIG. 9 illustrates the state transition in a case where the output luminance range is fixed and the input luminance range is changed. The state transition table of FIG. 9 corresponds to the state transition in a case where the user output setting is not changed and the user input setting is changed. Furthermore, the state transition table of FIG. 9 also corresponds to a case where the luminance range detection result of the input data is changed from the non-detection (Limited Range) state to the detection (Full Range) state in a state where the user output setting is not changed and the luminance range detection function is ON.

In the state transition table of FIG. 9, the output luminance range is fixed. The output range is either the Limited Range or the Full Range.

In the state transition table of FIG. 9, the input luminance range is changed. The input range is any one of a change from the luminance range detection result “not detected” to the luminance range detection result “detected”, a change from the Limited Range to the luminance range detection result “not detected”, a change from the Full Range to the luminance range detection result “not detected”, a change from the Limited Range to the Full Range, and a change from the Full Range to the Limited Range.

As an example, a state transition in a case where the input range is a change from the luminance range detection result “not detected” to the luminance range detection result “detected” in the state transition table of FIG. 9 (second and third rows from the top) will be described.

In a case where the output range is the Limited Range, since the input luminance range before the change is the Limited Range (luminance range detection result “not detected”) and the output luminance range is also the Limited Range, the original path is the through-path 61 (through output). In this case, since the input luminance range after the change is the Full Range (luminance range detection result “detected”) and the output luminance range is the Limited Range, the path after the change is a path (Full-Limited output) passing through the Full-Limited conversion unit 62. Therefore, the state transition is the transition T3-1 corresponding to the state transition from the through output to the Full-Limited output.

In a case where the output range is the Full Range, since the input luminance range before the change is the Limited Range and the output luminance range is the Full Range, the original path is a path (Limited-Full output) passing through the Limited-Full conversion unit 63. In this case, since the input luminance range after the change is the Full Range and the output luminance range is the Full Range, the path after the change is the through-path 61 (through output). Therefore, the state transition is the transition T1-2 corresponding to the state transition from the Limited-Full output to the through output.

Note that, in the state transition table of FIG. 9, in a case where the input range is a change from the Limited Range to the luminance range detection result “not detected” (fourth and fifth rows from the top), there is no change in the path before and after the change, and thus no state transition occurs.

Although description is omitted, in the state transition table of FIG. 9, the original path, the path after change, and the state transition can be determined from the input range and the output range similarly in a case where the input range corresponds to a change from the Full Range to the detection result “not detected” (sixth and seventh rows from the top), in a case where the input range corresponds to a change from the Limited Range to the Full Range (eighth and ninth rows from the top), and in a case where the input range corresponds to a change from the Full Range to the Limited Range (10th and 11th rows from the top).

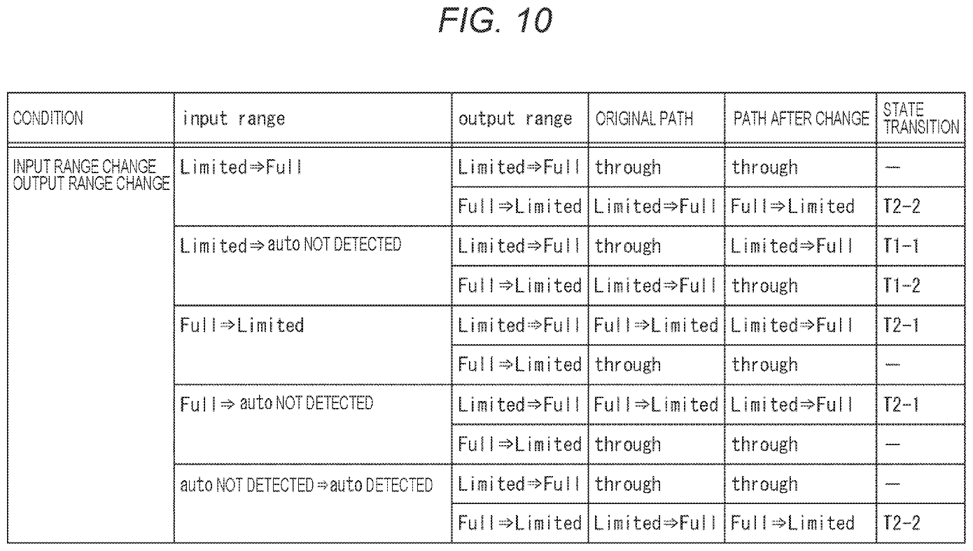

FIG. 10 illustrates the state transition in a case where both the output luminance range and the input luminance range are changed. The state transition table of FIG. 10 corresponds to the state transition in a case where the user output setting and the user input setting are changed. Furthermore, the state transition table of FIG. 10 also corresponds to a case where the luminance range detection result of the input data is changed from the non-detection (Limited Range) state to the detection (Full Range) state in a state where the user output setting is changed and the luminance range detection function is ON.

As an example, the state transition in a case where the input range corresponds to a change from the Limited Range to the Full Range in the state transition table of FIG. 10 (second and third rows from the top) will be described.

In a case where the output range is changed from the Limited Range to the Full Range, since the input luminance range before the change is the Limited Range and the output luminance range before the change is also the Limited Range, the original path is the through-path 61 (through output). In this case, since the input luminance range after the change is the Full Range and the output luminance range after the change is the Full Range, the path after the change is the through-path 61 (through output). Thus, no state transition occurs.

In a case where the output range is changed from the Full Range to the Limited Range, since the input luminance range before the change is the Limited Range and the output luminance range before the change is the Full Range, the original path is a path (Limited-Full output) passing through the Limited-Full conversion unit 63. In this case, since the input luminance range after the change is the Full Range and the output luminance range after the change is the Limited Range, the path after the change is a path (Full-Limited output) passing through the Full-Limited conversion unit 62. Therefore, the state transition is the transition T3-1 corresponding to the state transition from the Limited-Full output to the Full-Limited output.

Although description is omitted, in the state transition table of FIG. 10, the original path, the path after change, and the state transition can be determined from the input range and the output range similarly even in a case where the input range and the output range correspond to other conversion.

The state changing unit 91 includes, for example, table information which is information indicating the state transition table as described above. The state changing unit 91 outputs the state change notification to the counter selection unit 92 and the value selection unit 93 on the basis of the table information, and outputs the output path notification to the output selection unit 97.

However, the table information does not necessarily correspond to the state transition tables illustrated in FIGS. 8 to 10, and the state change notification and the output path notification do not need to be output on the basis of the table information.

The state change notification and the output path notification include, for example, any one or more pieces of information of “condition”, “input range”, “output range”, “original path”, “path after change”, and “state transition” of the state transition table. The state changing unit 91 may output the state change notification and the output path notification as the information for controlling the selection in the counter selection unit 92, the value selection unit 93, and the output selection unit 97. Furthermore, the state changing unit 91 may determine the contents of the selection in the counter selection unit 92, the value selection unit 93, and the output selection unit 97, and set the determined contents of the selection in the counter selection unit 92, the value selection unit 93, and the output selection unit 97 using the state change notification and the output path notification.

The state change notification output from the state changing unit 91 is input to the counter selection unit 92, and the auto count, the i range count, and the o range count output from the counting unit 52 are input to the counter selection unit 92.

The counter selection unit 92 selects any one of the auto count, the i range count, and the o range count on the basis of the state change notification, and outputs the selected auto count, i range count, and o range count to the value selection unit 93.

The state change notification output from the state changing unit 91 is input to the value selection unit 93, and any of the auto count, the i range count, and the o range count output from the counter selection unit 92 is input to the value selection unit 93. The bit depth is also input to the value selection unit 93.

The value selection unit 93 determines which one of the through output, the Full-Limited output, and the Limited-Full output is to be the output data, on the basis of the state change notification.

In a case where the state transition of the luminance range conversion occurs, the value selection unit 93 controls the blending processing of the through output, the Full-Limited output, and the Limited-Full output on the basis of the state change notification so as to prevent a sudden change in the luminance level of the video data as the output data.

Specifically, the value selection unit 93 generates parameters i, j, and k for determining blending ratios of the through output, the Full-Limited output, and the Limited-Full output on the basis of the contents of the state transition indicated by the state change notification. Furthermore, the value selection unit 93 generates parameters max-i, max-j, and max-k for determining the blending ratio of each output on the basis of the bit depth-dependent fixed value max.

For example, in a case where a transition between the state s1 (through output) and the state s2 (Limited-Full output) occurs, the value selection unit 93 outputs the parameter i to the multiplication unit 94-1, and outputs the parameter max-i to the multiplication unit 94-2. Furthermore, in a case where a transition between the state s2 (Limited-Full output) and the state s3 (Full-Limited output) occurs, the value selection unit 93 outputs the parameter j to the multiplication unit 94-3, and outputs the parameter max-j to the multiplication unit 94-4. In a case where a transition between the state s1 (through output) and the state s3 (Full-Limited output) occurs, the value selection unit 93 outputs the parameter k to the multiplication unit 94-5, and outputs the parameter max-k to the multiplication unit 94-6.

The value selection unit 93 sets parameters of the parameters i, j, and k on the basis of any one of the auto count, the i range count, and the o range count input from the counter selection unit 92.

Specifically, in a case where the state transition occurs, the value selection unit 93 sets the parameters i, j, and k on the basis of the count value corresponding to the state transition until a predetermined time elapses such that the luminance range of the transition source is gradually changed to the luminance range after the transition. In this case, as the parameters i, j, and k are changed, the parameters max-i, max-j, and max-k are also gradually changed.

For example, in a case where the transition T1-1 from the state s1 (through output) to the state s2 (Limited-Full output) occurs, when the transition T1-1 occurs due to the change of the output luminance range from the Limited Range to the Full Range while the input luminance range is fixed as the Limited Range (second row in FIG. 8), the value selection unit 93 changes the parameters i and max-i on the basis of the o range count selected by the counter selection unit 92.

Furthermore, in a case where the transition T1-1 from the state s1 (through output) to the state s2 (Limited-Full output) occurs, when the transition T1-1 occurs due to the change of the input luminance range from the Full Range to the luminance range detection result “not detected” while the output luminance range is fixed as the Full Range (seventh row in FIG. 9), the value selection unit 93 changes the parameters i and max-i on the basis of the auto range count selected by the counter selection unit 92.

The parameters i, j, k, max-i, max-j, and max-k, the through output, the Full-Limited output, and the Limited-Full output are input to the multiplication unit 94.

The multiplication unit 94 performs multiplication processing based on the parameters i, j, k, max-i, max-j, and max-k, on the through output, the Full-Limited output, and the Limited-Full output, and outputs data of the multiplication result to the addition unit 95.

Specifically, the parameter i is input from the value selection unit 93 to the multiplication unit 94-1. The Limited-Full output is input to the multiplication unit 94-1.

The multiplication unit 94-1 performs multiplication processing based on the parameter i, on the Limited-Full output, and outputs data of the multiplication result to the addition unit 95-1.

Furthermore, the parameter max-i is input from the value selection unit 93 to the multiplication unit 94-2. The through output is input to the multiplication unit 94-2.

The multiplication unit 94-2 performs multiplication processing based on the parameter max-i, on the through output, and outputs data of the multiplication result to the addition unit 95-1.

Each of the multiplication units 94-3 to 94-6 similarly performs multiplication processing of the input data and the parameter.

That is, the multiplication unit 94-3 performs multiplication processing based on the parameter j, on the Limited-Full output, and outputs data of the multiplication result to the addition unit 95-2. The multiplication unit 94-4 performs multiplication processing based on the parameter max-j, on the Full-Limited output, and outputs data of the multiplication result to the addition unit 95-2.

The multiplication unit 94-5 performs multiplication processing based on the parameter k, on the through output, and outputs data of the multiplication result to the addition unit 95-3. The multiplication unit 94-6 performs multiplication processing based on the parameter max-k, on the Full-Limited output, and outputs data of the multiplication result to the addition unit 95-3.

The addition unit 95 performs addition processing on the plurality of pieces of data input from the multiplication unit 94, and outputs data of the addition result to the bit shift unit 96.

Specifically, the addition unit 95-1 adds the data of the multiplication result input from the multiplication unit 94-1 and the data of the multiplication result input from the multiplication unit 94-2, and outputs the data of the addition result to the bit shift unit 96-1.

Similarly, the addition unit 95-2 adds the data of the multiplication result input from the multiplication unit 94-3 and the data of the multiplication result input from the multiplication unit 94-4, and outputs the data of the addition result to the bit shift unit 96-2. The addition unit 95-3 adds the data of the multiplication result input from the multiplication unit 94-5 and the data of the multiplication result input from the multiplication unit 94-6, and outputs the data of the addition result to the bit shift unit 96-3.

The bit shift unit 96 performs bit shift processing based on the bit depth-dependent fixed value, on the data input from the addition unit 95, and outputs data obtained by the bit shift processing to the output selection unit 97.

The output selection unit 97 selects any one of the outputs of the bit shift units 96-1 to 96-3 as the output data on the basis of the output selection notification input from the state changing unit 91. The output selection unit 97 outputs the output of the selected bit shift unit 96 as video data of video contents displayed on the video wall 15.

In the selection blending unit 64, the output data is selected by the processing. Furthermore, by the processing, in order to prevent a sudden change in the luminance level of the video data as the output data in a case where the state transition of the luminance range conversion occurs, the blending processing of the through output, the Full-Limited output, and the Limited-Full output is performed for a predetermined time.

However, after a predetermined time has elapsed from the occurrence of the state transition of the luminance range conversion, the parameters i, j, k, max-i, max-j, and max-k are set such that only the output corresponding to the path after the change among the outputs corresponding to the path before the change and the path after the change is input to the addition unit 95.

Such output blending processing makes it possible to reduce the uncomfortable feeling felt by the viewer of the video contents particularly due to the luminance change in a case where the luminance range is changed.

Note that the output blending processing described above has been described as an example of linearly blending each output. However, the blending ratio of each output is not limited to a linearly changing ratio. The selection blending unit 64 may perform the blending processing using a higher order ratio, for example, a ratio changed on the basis of a quadratic curve, or may perform the blending processing using an exponentially changed ratio.

Furthermore, the output selection processing described above has been described as an example in which the three parameters i, j, and k are set, and output data to be output to the video wall 15 is selected from the three pieces of the output data input to the output selection unit 97 via the bit shift units 96-1 to 96-3. However, the output selection processing is not limited to this example. For example, the value selection unit 93 may generate only the parameter corresponding to the state transition that has occurred.

### <<Description of Operation of Video Wall Controller>>

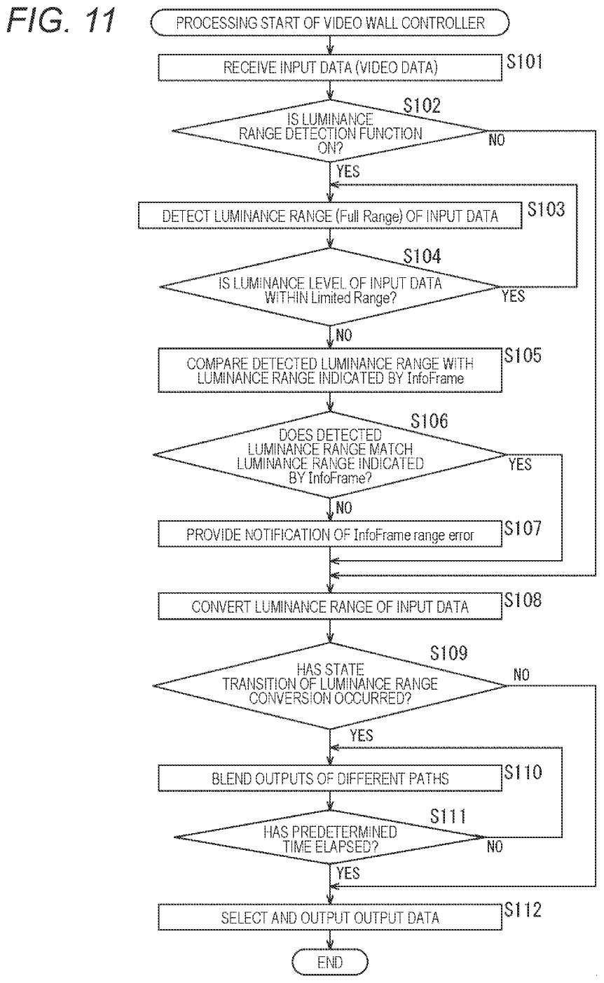

The operation processing of the video wall controller 14 will be described with reference to the flowchart of FIG. 11.

In step S101, the range detection unit 32 receives the input data input from the processor 13.

In step S102, in a case where the information stored in the automatic mode register 31 indicates that the luminance range detection function is ON, the range detection unit 32 causes the processing to proceed to the luminance range detection processing in step S103.

On the other hand, in a case where the ON/OFF setting information stored in the automatic mode register 31 does not indicate that the luminance range detection function is ON in step S102, the detection of the luminance range is not performed, and the processing proceeds to the luminance range conversion processing in step S108.

In step S103, the detection unit 41 of the range detection unit 32 detects whether or not the luminance level of the input data is within the Limited Range.

In a case where it is detected in step S104 that the luminance level of the input data is within the Limited Range, the processing returns to the luminance range detection processing in step S103.

On the other hand, in a case where it is determined in step S104 that the luminance level of the input data is outside the Limited Range, a detection result that the luminance range of the input data is the Full Range is stored in the detection result storage unit 42, and is output to the error notification unit 43 as a temporary detection result. The processing proceeds to luminance range information comparison processing in step S105.

In step S105, the error notification unit 43 compares the luminance range of the input data indicated by the temporary detection result with the luminance range of the input data indicated by the InfoFrame. Furthermore, the error notification unit 43 outputs the temporary detection result to the range conversion unit 33 as the detection result of the luminance range of the input data.

In step S106, in a case where the luminance range of the input data indicated by the temporary detection result is different from the luminance range of the input data indicated by the InfoFrame, the processing proceeds to error notification processing in step S107.

In step S106, in a case where the luminance range of the input data indicated by the temporary detection result matches the luminance range of the input data indicated by the InfoFrame, the processing proceeds to luminance range conversion processing in step S108.

In step S107, the error notification unit 43 outputs, to the output device, notification information for providing notification that the luminance range of the input data indicated by the temporary detection result is different from the luminance range of the input data indicated by the InfoFrame.

In step S108, the Full-Limited conversion unit 62 and the Limited-Full conversion unit 63 of the range conversion unit 33 convert the luminance range of the input data, and output the converted luminance range of the input data to the selection blending unit 64. Furthermore, the through-path 61 of the range conversion unit 33 outputs the input data as it is to the selection blending unit 64 without converting the luminance range of the input data.

In step S109, in a case where the state transition of the luminance range conversion occurs on the basis of any one of the user input setting, the user output setting, and the detection result of the range conversion unit 33, the processing proceeds to the output blending processing in step S110.

On the other hand, in a case where the state transition of the luminance range conversion does not occur in step S109, the processing proceeds to the output data selection processing in step S112.

In step S110, the selection blending unit 64 blends a plurality of outputs obtained by the processing of step S108 at a predetermined blending ratio for a predetermined time according to the state transition that has occurred.

In a case where the predetermined time has elapsed from the occurrence of the state transition in step S111, the processing proceeds to the output data selection processing in step S112.

On the other hand, in a case where the predetermined time has not elapsed from the occurrence of the state transition in step S111, the processing returns to the output blending processing in step S108.

In step S112, the selection blending unit 64 selects the output data to be output to the video wall 15, and outputs the selected output data to the video wall 15.

By the above operation processing, the video wall controller 14 can perform the luminance range detection processing, the luminance range conversion processing, and the output data selection processing on the input video data.

Furthermore, the video wall controller 14 can also perform the error notification processing in a case where the luminance range of the input data indicated by the InfoFrame is incorrect, and the output blending processing in a case where the state transition of the luminance range conversion occurs.

### <<Setting Method of Luminance Range>>

Next, a setting method of the user input setting which is the setting information of the luminance range of the input data and a setting method of the user output setting which is the setting information of the luminance range of the output data will be described.

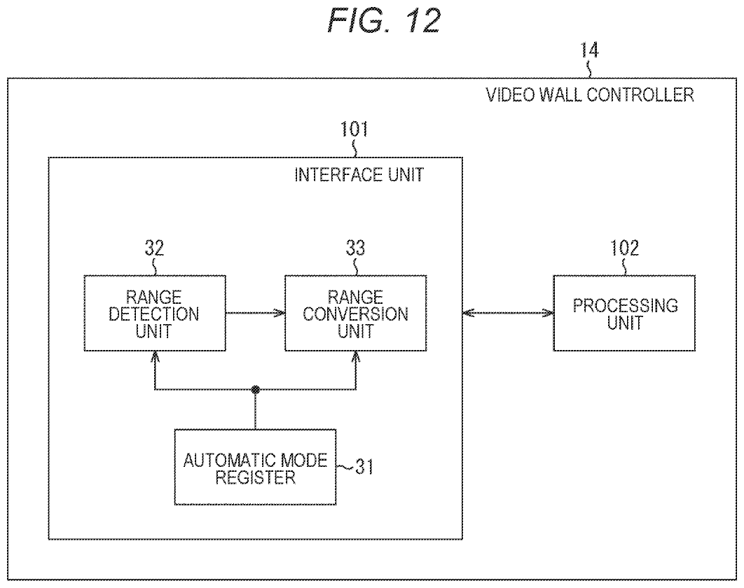

FIG. 12 is a block diagram illustrating a more detailed functional configuration example of the video wall controller 14.

The video wall controller 14 illustrated in FIG. 12 includes an interface unit 101, and a processing unit 102.

The interface unit 101 includes the automatic mode register 31, the range detection unit 32, and the range conversion unit 33 illustrated in FIG. 2.

The processing unit 102 controls the entire operation of the video wall controller 14. The processing unit 102 is realized by, for example, a CPU.

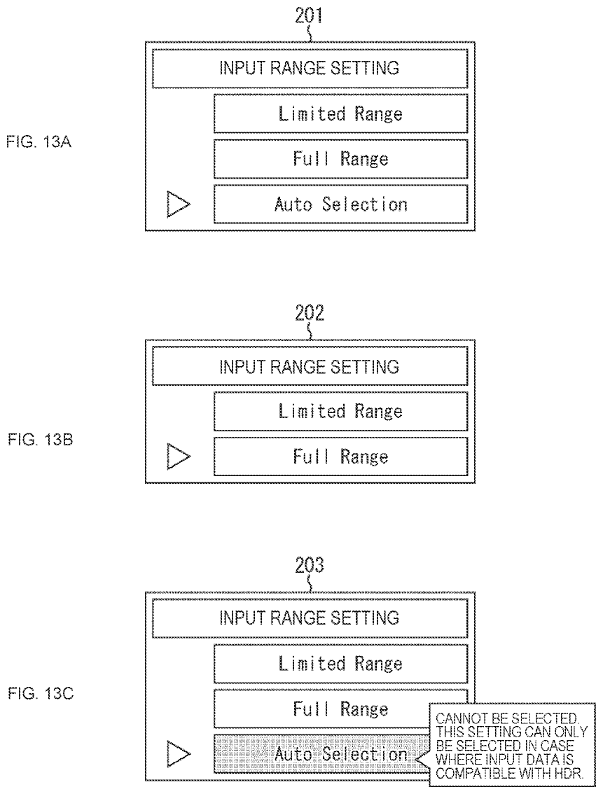

In a case of setting the luminance range of the input data, the processing unit 102 outputs, for example, a GUI 201 illustrated in A of FIG. 13. The GUI 201 may be displayed on a display unit (not illustrated) included in the video wall controller 14, or may be displayed on an external display device such as the video wall 15.

In a case where the user input setting is performed, for example, the user selects, on the GUI, an appropriate option from the Limited Range, the Full Range, and the Auto Selection (luminance range detection) illustrated in the GUI 201.

In a case where the user input setting is performed, the processing unit 102 stores the selected setting in a storage unit (not illustrated). Furthermore, in a case where the Auto Selection is selected in the user input setting, the processing unit 102 stores the ON/OFF setting information indicating that the luminance range detection function is ON, in the automatic mode register 31.

The user input setting may be performed using an interface such as a physical key or a touch panel provided in the video wall controller 14, or may be performed using an external device provided for operating the video wall controller 14, such as a mouse, a keyboard, and a remote controller. Furthermore, the user input setting may be performed using a device connected to the video wall controller 14 such as the PC 11.

The user output setting can also be performed in a similar procedure. There is no Auto Selection setting in the user output setting. The processing unit 102 can receive the setting by the user by displaying a GUI including options similar to the options of the GUI 202 illustrated in B of FIG. 13, as the output range setting.

### MODIFIED EXAMPLES

### Modified Example 1

The Auto Selection of the user input setting may be selectable according to the input data.

Specifically, for example, only in a case where the input video data is compatible with high dynamic range (HDR), the option of the auto selection may be included in the GUI 201. Furthermore, only in a case where the input video data is compatible with HDR, the automatic mode register 31 may be enabled.

In this case, for example, in a case where the information indicating that the video data is HDR is included in the InfoFrame included in the video data, the processing unit 102 performs display control processing of the GUI corresponding to the HDR video data, and enables the automatic mode register 31.

For example, in a case where the input video data is video data not compatible with HDR, the option of the Auto Selection may not be displayed as illustrated in the GUI 202 in B of FIG. 13.

In this case, since the setting of the Auto Selection can be enabled only in a case where the input data is compatible with HDR, the range detection unit 32 performs the luminance range detection only on the input data compatible with HDR.

Furthermore, in a case where the input video data is video data that is not compatible with HDR, the option of the Auto Selection may be displayed in an unselectable state.

As in a GUI 203 illustrated in C of FIG. 13, a notification indicating that the setting of the Auto Selection cannot be selected may be made in response to an attempt by the user to select the option of the Auto Selection. The notification presented to the user may include a reason why the setting of the Auto Selection cannot be selected.

Furthermore, a notification indicating that the setting of the Auto Selection cannot be selected may be presented in a color or size different from the color or size of other options.

Furthermore, for example, only in a case where the bit depth included in the input video data is 10 bits or more, the option of the Auto Selection may be included in the GUI 201. Similarly, only in a case where the bit depth included in the input video data is 10 bits or more, the automatic mode register 31 may be enabled.

In this case, the display control of the GUI 202 and the GUI 203 may be performed similarly to the case where the input video data is video data that is not compatible with HDR. Specifically, depending on whether or not the bit depth is 10 bits or more, whether or not an option of the Auto Selection can be selected, whether or not an option of the Auto Selection is displayed, an appearance of an option of the Auto Selection, display of the above-described notification, and the like may be controlled.

Furthermore, the processing described above may be performed only in a case where the bit depth included in the input video data is 10 bits or more and the input video data is compatible with HDR. By the processing, it is possible to automatically detect the luminance range of the input data that requires more faithful signal reproduction.

Furthermore, the processing described in the present modified example may be performed on the options other than Auto Selection included in the user input setting, specifically, any of the options of the Limited Range and the Full Range.

Furthermore, in the user output setting, the processing described in the present modified example may be performed.

### Modified Example 2

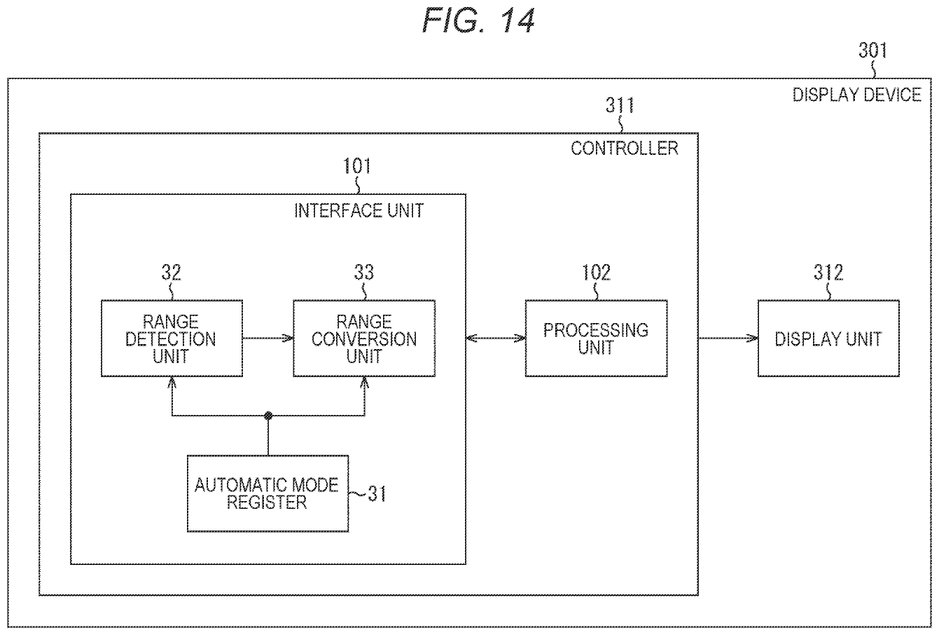

FIG. 14 is a block diagram illustrating a functional configuration example of a display device 301.

The display device 301 includes a controller 311, and a display unit 312.

The controller 311 includes the interface unit 101, and the processing unit 102. The controller 311 may have a configuration similar to, for example, the video wall controller 14 illustrated in FIG. 12.

The display device 301 is, for example, a TV, a PC display, a master monitor, or the like. As described above, a function similar to the function of the video wall controller 14 may be mounted on the display device.

### Modified Example 3

In the above description, the luminance range is detected by detecting the luminance level of the input data, but the detection result of the luminance range may be replaced with the luminance range indicated by the InfoFrame. In this case, instead of the temporary detection result input from the detection result storage unit 42, the error notification unit 43 outputs the luminance range indicated by the input InfoFrame to the range conversion unit 33 as the detection result.

As a result, even in the case of using the InfoFrame, it is possible to obtain the output data subjected to the blending processing in the range conversion unit 33, and it is possible to reduce the uncomfortable feeling felt by the viewer of the video contents with respect to the luminance change caused by the luminance range conversion.

In the present embodiment, the description has been given using the configuration in which the video data is input from the processor 13 to the video wall controller 14, but the configuration of display system 1 is not limited thereto. For example, the video wall controller 14 may be directly connected to one or a plurality of video output devices via wired or wireless connection.

Furthermore, the processor 13 may also be a hub, a repeater, and a booster of the connection interface, and may output the input video data to the video wall controller 14 without performing format conversion or signal conversion.

In the present embodiment, the description has been given using the configuration in which the display system 1 has the video wall including a plurality of display units in a tile shape, but the configuration of the display system 1 is not limited thereto. For example, instead of the video wall, a display device including one display unit such as a general TV or display may be provided, or a video wall including one display unit may be provided as the display device.

The display system 1 may include a plurality of types of devices selected from a video wall, a TV, and a display. Furthermore, the display described above may be a master monitor. In a case where the display device is a master monitor, it is possible to more faithfully reproduce colors at a video production site by applying the technology of the present disclosure. Note that, in a case where the display system 1 is not a video wall, the video wall controller 14 may be regarded as a controller that controls a display device other than the video wall, and the video wall 15 may be regarded as a display device other than the video wall including a TV or a display.

Furthermore, in the present embodiment, the description has been made in which the display system 1 includes the PC 11, the video server 12, the processor 13, the video wall controller 14, and the video wall 15 as separate devices, but the configuration of the display system 1 is not limited thereto. For example, as described above, a plurality of constituents of the display system 1 may be mounted on one device.

Specifically, for example, the video wall controller 14 may be mounted as the same device as the video wall 15. Furthermore, as described above, the controller 311 may be mounted on the display device 301.

The display system 1 does not need to include all the constituents illustrated in FIG. 1, and may have a configuration including, for example, only the video wall controller 14 and the video wall 15 individually or integrally.

The video output device is not limited to the PC 11 and the video server 12, and may be a gaming device, an HDD recorder, a set top box, a disk player, or the like.

In the present embodiment, in a case where the bit depth is 8 bits, the luminance range in which the gradations in the range of 16 to 235 of the total 256 gradations of the Full Range are used has been described as the Limited Range, but the method of taking the Limited Range is not limited thereto. For example, in a case where the bit depth is 8 bits, gradations in a range of 16 to 240 may correspond to the Limited Range, and gradations in other ranges may correspond to the Limited Range. Furthermore, the configuration of an arithmetic unit in the path selection unit 51 and the bit depth-dependent fixed values b to h used in the arithmetic operation are set according to the method of taking the Limited Range.

### <Configuration of Computer>

The above-mentioned series of processing can be executed by hardware or can be executed by software. In a case where a series of processing is executed by the software, a program which forms the software is installed on a computer.

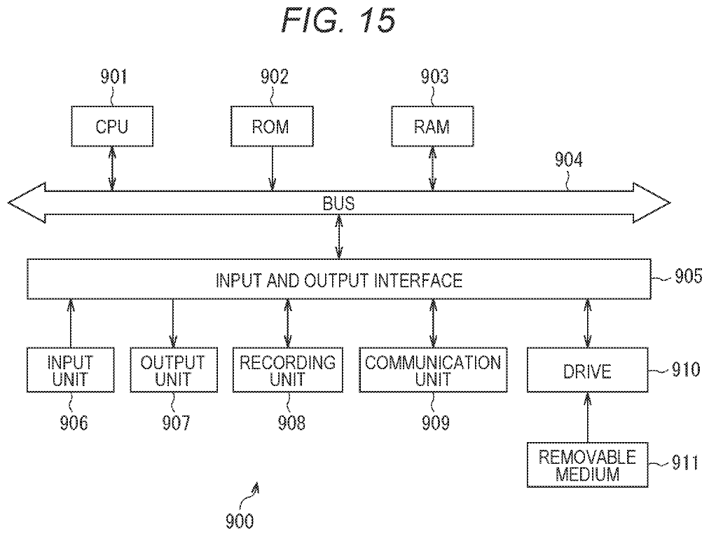

FIG. 15 is a diagram illustrating a configuration example of hardware of a computer that executes the above-described series of processing by a program.

In a computer 900, a central processing unit (CPU) 901, a read only memory (ROM) 902, and a random access memory (RAM) 903 are mutually connected by a bus 904. Moreover, an input and output interface 905 is connected to the bus 904. An input unit 906, an output unit 907, a recording unit 908, a communication unit 909, and a drive 910 are connected to the input and output interface 905.

The input unit 906 includes a keyboard, a mouse, a microphone, and the like. The output unit 907 includes a display, a speaker, and the like. The recording unit 908 includes a hard disk, a non-volatile memory, and the like. The communication unit 909 includes a network interface and the like. The drive 910 drives a removable medium 911 such as a magnetic disk, an optical disk, a magneto-optical disk, or a semiconductor memory.

In the computer 900 configured in the above-described manner, the CPU 901 loads a program recorded in the ROM 902 and the recording unit 908 on the RAM 903 via the input and output interface 905 and the bus 904 to execute the program, and as a result, the above-described series of processing is performed.

The program executed by the computer 900 (CPU 901) can be provided by being recorded in the removable medium 911 as a package medium and the like, for example. Furthermore, the program can be provided via a wired or wireless transmission medium such as a local area network, the Internet, or digital satellite broadcasting.

In the computer 900, the program may be installed on the recording unit 908 via the input and output interface 905 by mounting the removable medium 911 on the drive 910. Furthermore, the program may be received by the communication unit 909 via the wired or wireless transmission medium to be installed on the recording unit 908. In addition, the program can be installed in the ROM 902 or the recording unit 908 in advance.

Here, in this specification, the processing to be performed by the computer in accordance with the program is not necessarily performed in chronological order according to the sequences described in the flowcharts. That is, the processing to be performed by the computer in accordance with the program includes processing to be executed in parallel or independently of one another (parallel processing or object-based processing, for example). Furthermore, the program may be processed by one computer (processing circuit) or may be distributed and processed by a plurality of computers.

Note that in the specification, the system means a set of a plurality of constituents (devices, modules (components), and the like), and it does not matter whether or not all the constituents are in the same housing. Therefore, a plurality of devices housed in separate housings and connected via a network and one device in which a plurality of modules are housed in one housing are both systems.

The effects described in the specification are merely examples and are not limited, and other effects may be provided.

### Combination Examples of Configurations

The present technology can also have the following configurations.

(1) An information processing system including:
a detection unit that detects a luminance range of input data; and
a conversion unit that converts the luminance range of the input data on the basis of a detection result of the detection unit and outputs the luminance range.

(2) The information processing system described in (1),
in which the luminance range is a limited range or a full range, and
the conversion unit performs conversion between data of the limited range and data of the full range.

(3) The information processing system described in (2),
in which the limited range corresponds to a partial range of the full range, and
the detection unit detects whether or not the luminance level of the input data is within the limited range.

(4) The information processing system described in any one of (1) to (3),
in which the detection unit detects the luminance range of the input data on the basis of bit depth information included in the input data.

(5) The information processing system described in (4),
in which the bit depth information is information that specifies a bit depth of the input data as any one of 8 bits, 10 bits, 12 bits, and 16 bits.

(6) The information processing system described in (4),
in which in a case where the bit depth information indicates that a bit depth of the input data is 10 bits or more, the detection unit detects the luminance range of the input data.

(7) The information processing system described in any one of (4) to (6),
in which the detection unit detects the luminance range of the input data on the basis of the bit depth information included in General Control Packet specified in HDMI standards.

(8) The information processing system described in any one of (1) to (7),
in which the conversion unit performs conversion such that luminance is gently changed in a case where the luminance range of the input data is converted.

(9) The information processing system described in any one of (1) to (8),
in which the conversion unit performs conversion such that data of the luminance range before conversion and data of the luminance range after conversion are blended in a case where the luminance range of the input data is converted.

(10) The information processing system described in any one of (1) to (9),
in which the conversion unit performs conversion such that data of the luminance range before conversion and data of the luminance range after conversion are blended on the basis of elapsed time from a start of conversion in a case where the luminance range of the input data is converted.

(11) The information processing system described in any one of (1) to (10),
in which the conversion unit performs conversion such that luminance is gently changed in a case where data of the limited range is converted into data of the full range.

(12) The information processing system described in any one of (1) to (11),
in which in a case where the luminance range of the input data is the full range, the conversion unit converts the input data into data of the limited range.

(13) The information processing system described in any one of (1) to (12),
in which in a case where setting of a luminance range of output data corresponds to the limited range and the luminance range of the input data is the limited range, the conversion unit outputs the input data without converting the luminance range of the input data.

(14) The information processing system described in any one of (1) to (13),
in which in a case where the input data is video data compatible with high dynamic range, the detection unit detects the luminance range of the input data.

(15) The information processing system described in any one of (1) to (14),
in which in a case where information indicating high dynamic range is included in InfoFrame included in the input data, the detection unit detects the luminance range of the input data.

(16) The information processing system described in any one of (1) to (15), further including:
a processing unit that outputs selection information for enabling a detection function of the detection unit in a case where the input data is video data compatible with high dynamic range.

(17) The information processing system described in any one of (1) to (16),
in which the detection unit compares the luminance range of the input data indicated by the detection result with the luminance range of the input data indicated by InfoFrame included in the input data, and outputs notification information in a case where the luminance ranges are different from each other.

(18) The information processing system described in (1) or (2),
in which the detection unit outputs the luminance range of the input data indicated by InfoFrame included in the input data, as the detection result, and
the conversion unit converts the luminance range of the input data on the basis of the luminance range of the input data indicated by the InfoFrame and outputs the luminance range.

(19) The information processing system described in any one of (1) to (18), further including:
a display unit that displays an image on the basis of data output from the conversion unit.

(20) An information processing method, the information processing method including:
detecting a luminance range of input data by an information processing system; and
converting the luminance range of the input data on the basis of a detection result of the luminance range of the input data and outputting the luminance range by the information processing system.

### REFERENCE SIGNS LIST

1 Display system
11 PC
12 Video server
13 Processor
14 Video wall controller
15 Video wall
21, 21-1 to 21-n Display unit
31 Automatic mode register
32 Range detection unit
33 Range conversion unit
41 Detection unit
42 Detection result storage unit
43 Error notification unit
51 Path selection unit
52 Counting unit
61 through-path
62 Full-Limited conversion unit
63 Limited-Full conversion unit
64 Selection blending unit
71 Automatic setting counting unit
72 Input setting counting unit 73 Output setting counting unit 81, 86, 94-1 to 94-6 Multiplication unit 82, 87, 96-1 to 96-3 Bit shift unit 83, 84, 88, 95-1 to 95-3 Addition unit 85 Subtraction unit 91 State changing unit 92 Counter selection unit 93 Value selection unit 97 Output selection unit 101 Interface unit 102 Processing unit 201 to 203 GUI 301 Display device 311 Controller 312 Display unit

1. An information processing system comprising:
a detection unit that detects a luminance range of input data; and
a conversion unit that converts the luminance range of the input data on a basis of a detection result of the detection unit and outputs the luminance range.

2. The information processing system according to claim 1,
wherein the luminance range is a limited range or a full range, and
the conversion unit performs conversion between data of the limited range and data of the full range.

3. The information processing system according to claim 2,
wherein the limited range corresponds to a partial range of the full range, and
the detection unit detects whether or not the luminance level of the input data is within the limited range.

4. The information processing system according to claim 1, wherein the detection unit detects the luminance range of the input data on a basis of bit depth information included in the input data.

5. The information processing system according to claim 4, wherein the bit depth information is information that specifies a bit depth of the input data as any one of 8 bits, 10 bits, 12 bits, and 16 bits.

6. The information processing system according to claim 4, wherein in a case where the bit depth information indicates that a bit depth of the input data is 10 bits or more, the detection unit detects the luminance range of the input data.

7. The information processing system according to claim 4, wherein the detection unit detects the luminance range of the input data on a basis of the bit depth information included in General Control Packet specified in HDMI standards.

8. The information processing system according to claim 1, wherein the conversion unit performs conversion such that luminance is gently changed in a case where the luminance range of the input data is converted.

9. The information processing system according to claim 1, wherein the conversion unit performs conversion such that data of the luminance range before conversion and data of the luminance range after conversion are blended in a case where the luminance range of the input data is converted.

10. The information processing system according to claim 1, wherein the conversion unit performs conversion such that data of the luminance range before conversion and data of the luminance range after conversion are blended on a basis of elapsed time from a start of conversion in a case where the luminance range of the input data is converted.

11. The information processing system according to claim 1, wherein the conversion unit performs conversion such that luminance is gently changed in a case where data of the limited range is converted into data of the full range.

12. The information processing system according to claim 1, wherein in a case where the luminance range of the input data is the full range, the conversion unit converts the input data into data of the limited range.

13. The information processing system according to claim 1, wherein in a case where setting of a luminance range of output data corresponds to the limited range and the luminance range of the input data is the limited range, the conversion unit outputs the input data without converting the luminance range of the input data.

14. The information processing system according to claim 1, wherein in a case where the input data is video data compatible with high dynamic range, the detection unit detects the luminance range of the input data.

15. The information processing system according to claim 1, wherein in a case where information indicating high dynamic range is included in InfoFrame included in the input data, the detection unit detects the luminance range of the input data.

16. The information processing system according to claim 1, further comprising: a processing unit that outputs selection information for enabling a detection function of the detection unit in a case where the input data is video data compatible with high dynamic range.

17. The information processing system according to claim 1, wherein the detection unit compares the luminance range of the input data indicated by the detection result with the luminance range of the input data indicated by InfoFrame included in the input data, and outputs notification information in a case where the luminance ranges are different from each other.

18. The information processing system according to claim 1,
wherein the detection unit outputs the luminance range of the input data indicated by InfoFrame included in the input data, as the detection result, and
the conversion unit converts the luminance range of the input data on a basis of the luminance range of the input data indicated by the InfoFrame and outputs the luminance range.

19. The information processing system according to claim 1, further comprising: a display unit that displays an image on a basis of data output from the conversion unit.

20. An information processing method, the information processing method comprising:
detecting a luminance range of input data by an information processing system; and
converting the luminance range of the input data on a basis of a detection result of the luminance range of the input data and outputting the luminance range by the information processing system.
